(19) United States
(12) Patent Application Publication
(10) Pub. No.: US 2005/0259305 A1
(43) Pub. Date: Nov. 24, 2005

(54) Hologram device

(75) Inventor: Yoshihiro Someno, Tokyo (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/129,622

(22) Filed: May 13, 2005

(30) Foreign Application Priority Data
May 21, 2004 (JP) 2004-152136

(51) Int. Cl. G02B 5/32

(52) U.S. Cl. 359/35; 359/30

(57) ABSTRACT

There is provided a hologram device including a light source for generating light beams, in which the light beams emitted from the light source are incident on holograms formed on a recording medium and thus information recorded on the holograms is read. In addition, the light source includes a laser having plural peak wavelengths at the emission intensity of light beams to be generated, and a separation grating for emitting the light beams emitted from the laser at a plurality of different angles for each of the peak wavelengths.

### BACKGROUND OF THE INVENTION

1. Field of the Invention

The present invention relates to a hologram device that reproduces information from a recording medium on which the information is recorded using a principle of a hologram, and more specifically, to a hologram device having a light source in which plural light beams each having a different wavelength are generated.

2. Description of the Related Art

Conventionally, as a storage device used in a computer or the like, storage devices are widely being used in which information is two-dimensionally written or read with respect to a recording medium by a magnetic or optical method. A hard disk is known as a storage device using a magnetic recording medium, and a CD or DVD is known as a storage device using an optical recording medium. These storage devices have remarkably advanced in a recording density to meet a demand on large capacity. Also, as a means for much lager capacity, storage devices using the principle of a hologram are under development.

The hologram storage device reads and reproduces information which is recorded on the recording medium as holograms in a page unit. On the recording medium, coded information in a page unit is written as a pattern, for example, in which an index of refraction is varied. The pattern is a hologram formed by interference between an object beam and a reference beam in a recording device, and to read the information from the recording medium, the reference beam only is incident on the recording medium, diffracted by the hologram pattern, and received in a photoelectric transducer such as a CCD or a CMOS, and thus the written information can be reproduced.

One of the most prominent features of the hologram storage device is that it can multi-record the information spatially with respect to the recording medium, thereby obtaining a high storage density. As methods of a multi-space, there are known a multi-angle in which the incidence angle of a reference beam is varied upon recording information and a multi-wavelength in which the wavelength of the reference beam is varied upon recording information. Of those mentioned above, to reproduce the information from the recording medium on which the information is multi-recorded by the multi-wavelength, a wavelength-tunable light source, in which light beams having plural wavelengths can oscillate, is needed as a light source of the reference beam.

As a conventional wavelength-tunable light source, there is known one in which an oscillating wavelength is tuned by varying the length of a resonator of a laser thermally or mechanically. Also, there is known a wavelength-tunable light source in which the oscillating wavelength is tuned by current injection with respect to a grating of a DFB laser. A wavelength-tunable laser in which the length of a resonator is mechanically tuned is disclosed in Japanese Unexamined Patent Application Publication No. 2003-69146. In addition, a wavelength-tunable laser using the DFB laser is disclosed in Japanese Unexamined Patent Application Publication No. 5-7056.

However, the conventional wavelength-tunable light sources used in the hologram devices are very expensive as compared to general lasers, because the length of the resonator of the laser should be varied minutely and accurately in the wavelength-tunable laser in which the length of the resonator is varied, and because a periodic structure should be installed inside a semiconductor laser in the DFB laser.

Further, when the multi-wavelength is not performed, the multi-angle is performed. However, in this case, an angle-tuning mechanism is required, which leads to a complicated structure and a high cost.

### SUMMARY OF THE INVENTION

The present invention is designed to solve the above problems, and it is an object of the invention to provide a hologram device in which holograms recorded in a high density can be reproduced by a simple mechanism.

In order to achieve the above object, according to an aspect of the invention, a hologram device includes a light source for generating light beams, in which the light beams emitted from the light source are incident on holograms formed on a recording medium and thus information recorded on the holograms is read. In addition, the light source includes a laser having plural peak wavelengths at the emission intensity of light beams to be generated, and a separation grating for emitting the light beams emitted from the laser at a plurality of different angles for each of the peak wavelengths.

Further, in the hologram device according to the invention, it is preferable that the light source further includes an optical shutter by which each of the light beams emitted from the separation grating is transmitted or non-transmitted.

Furthermore, in the hologram device according to the invention, it is preferable that an incidence surface and an emission surface of the separation grating are respectively formed with a diffraction grating.

Moreover, in the hologram device according to the invention, it is preferable that the separation grating is formed with holograms.

In addition, in the hologram device according to the invention, it is preferable to further include a condensing means 14 that is provided between the light source, in which a wavelength is tunable, and the recording medium and that condenses each of the light beams passing through the optical shutter onto approximately the same location of the recording medium.

### BRIEF DESCRIPTION OF THE DRAWINGS

FIG. 1 is a schematic diagram showing a hologram device of the embodiment;

FIG. 2 is a diagram showing a distribution of an emission intensity of a laser used for the hologram device of the embodiment;

FIG. 3 shows an enlarged cross-sectional view of a separation grating;

FIG. 4 shows an enlarged cross-sectional view of another separation grating;

FIG. 5 is a schematic diagram showing a hologram device in which a light beam, having a different wavelength from that of FIG. 1, is transmitted; and

FIG. 6 is a schematic diagram showing a hologram device in which a light beam, having a different wavelength from those of FIGS. 1 and 5, is transmitted.

### DESCRIPTION OF THE PREFERRED EMBODIMENT

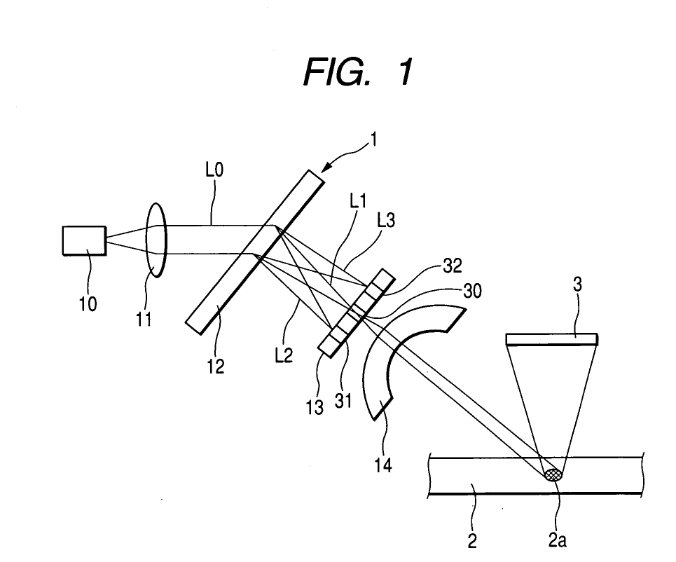

Hereinafter, an embodiment of the invention will be described in detail with reference to the accompanying drawings. FIG. 1 is a schematic diagram showing a hologram device of the present embodiment. As shown in the figure, the hologram device of the embodiment is configured such that light beams generated by a light source 1 are incident on a recording medium 2 through a condensing means 14, then the light beams diffracted by a hologram 2a formed in the recording medium 2 are received in a light receiving unit 3, and then information recorded in the hologram 2a is reproduced.

The light source 1 has a laser 10 for generating light beams, a lens 11 by which divergent light beams generated by the laser 10 become a concentrated light beam, and a separation grating 12 by which incident light beams are emitted at different angles for each wavelength. Also, there is further provided an optical shutter 13 by which each of the light beams separated are independently transmitted or non-transmitted.

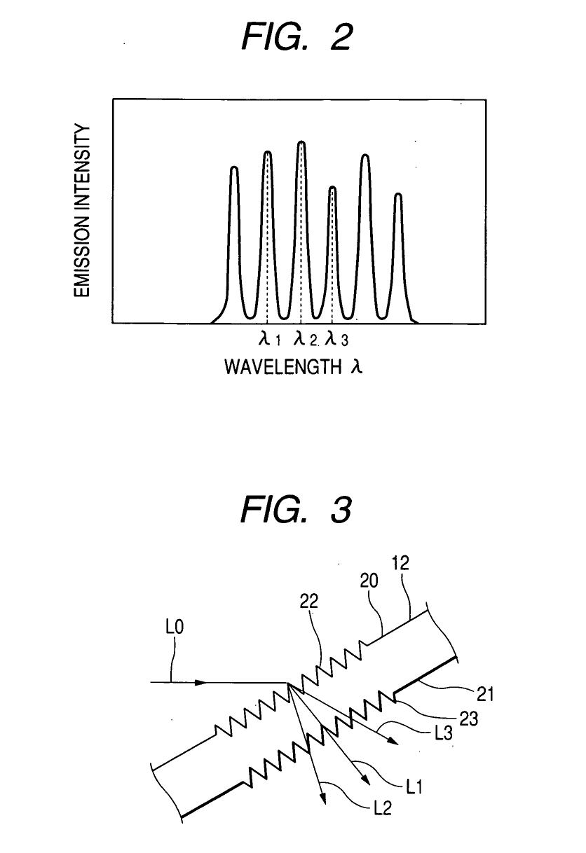

Here, the laser 10 used as a light source has a characteristic that a peak of an emission intensity exists for plural wavelengths. FIG. 2 shows a distribution of the emission intensity with respect to wavelengths of the laser 10. As shown in the figure, the laser 10 has a characteristic that plural peaks of the emission intensity exist within a predetermined wavelength range. Also, a distance between the peaks is about 1 nm.

Such a characteristic is shown in a Fabry-Perot type semiconductor laser which is being widely used. In a low-priced semiconductor laser, end surfaces of the resonator do not necessarily have uniform plane shape, but may be formed with uneven portions. Thereby, the length of the resonator is different depending on location of the resonator, so that light beams having plural wavelengths oscillate. As a result, the characteristic shown in FIG. 2 is obtained. In the present embodiment, light beams having wavelengths of λ1, λ2 and λ3 are used among peaks of the emission intensity shown in FIG. 2.

The separation grating 12 emits incident light beams at different angles for each wavelength, that is, the light beams, having plural wavelengths, emitted from the laser 10 are emitted at different angles, respectively. In FIG. 1, a light beam L0 is incident on the separation grating 12, and a light beam having a wavelength of λ1, a light beam having a wavelength of λ2 and a light beam having a wavelength of λ3, which are all emitted from the separation grating 12, become light beams L1, L2 and L3 and are emitted at different angles, respectively.

Details of the separation grating 12 are as follows. FIG. 3 shows an enlarged cross-sectional view of the separation grating 12. As shown in the figure, an incident surface 20 and an emission surface 21 of the separation grating 12 are respectively formed with an incidence diffraction grating 22 and an emission diffraction grating 23. Since a light beam incident on the diffraction grating is diffracted at different angles for each wavelength, the incident light beam L0, including a plurality of wavelengths, emitted from the laser 10 is emitted at different angles for each wavelength.

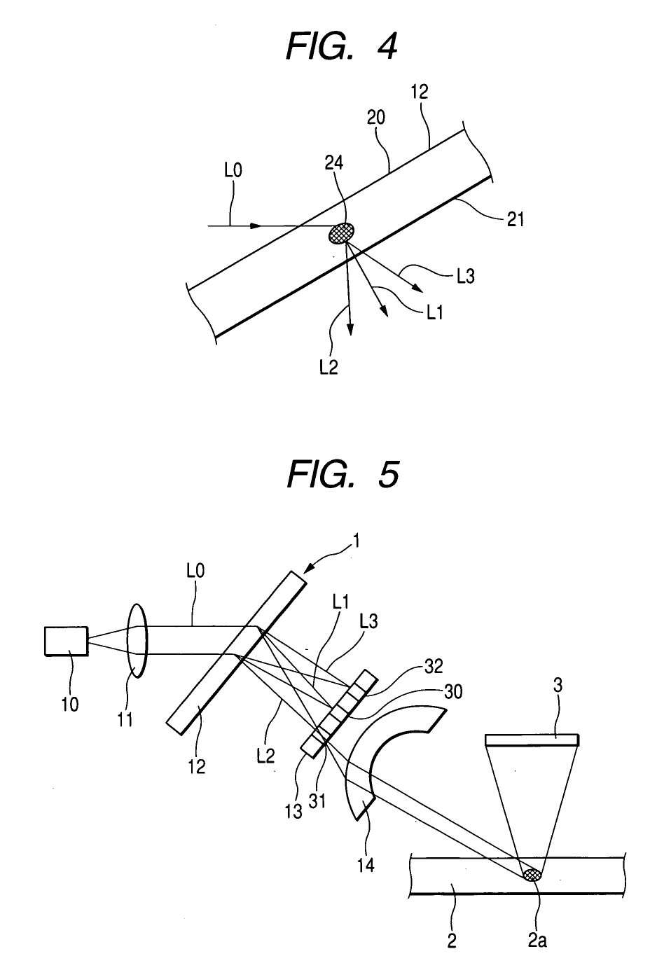

Further, the separation grating 12 may be configured differently from the structure in which the incidence surface 20 and the emission surface 21 of the separation grating 12 are respectively formed with the diffraction grating. FIG. 4 shows an enlarged cross-sectional view of another separation grating 12 different from that of FIG. 3. Here, a hologram 24 is formed in the separation grating 12. The hologram 24 is multi-formed with a plurality of holograms.

Specifically, the hologram 24 is formed by sequentially varying the angle of an object beam while fixing the angle of a reference beam, with the light beams having wavelengths of λ1, λ2 and λ3 being used as the reference beam and the object beam constituting the hologram 24. When the light beam L0 is incident on the hologram 24 multi-formed as mentioned above, the light beam having a wavelength of λ1 is emitted as a light beam L1, the light beam having a wavelength of λ2 is emitted as a light beam L2 at an angle different from that of the light beam L1, and a light beam having a wavelength of λ3 is emitted as a light beam L3 at an angle different from those of the light beams L1 and L2.

When the incidence surface 20 and the emission surface 21 of the separation grating 12 are respectively formed with the diffraction grating as shown in FIG. 3, an emission angle difference in the light beams each having a different wavelength is extremely small. Meanwhile, when the separation grating 12 is formed with the hologram 24 as shown in FIG. 4, it is necessary to secure an angle difference enough to separate the light beams each having a different wavelength, and accordingly, the emission angle difference in the light beams each having a different wavelength becomes large as compared to that in FIG. 3.

One of the light beams, separated for each wavelength as mentioned above, is selectively incident on a hologram. The optical shutter 13 provided in the light source 1 can selectively transmit one of the plurality of light beams. The optical shutter 13 in the embodiment has a first shutter 30 provided on an optical path of the light beam L1 having a wavelength of λ1, a second shutter 31 provided on an optical path of the light beam L2 having a wavelength of λ2, and a third shutter 32 provided on an optical path of the light beam L3 having a wavelength of λ3 in order to transmit or non-transmit the light beams. These shutters each are composed of liquid crystal and can independently switch transmission and non-transmission of the light beams by applying a voltage.

In FIG. 1, the first shutter 30 of the optical shutter 13 is in a state in which light beams are transmitted, and the second and third shutters 31 and 32 are in a state in which the light beams are non-transmitted. Thereby, the light beam L1 only, having a wavelength of λ1, passing through the first shutter 30 transmits the optical shutter 13. The light beam L1, which has passed through the optical shutter 13, is incident on the hologram 2a, which is formed in the recording medium 2, through a condensing means 14.

FIGS. 7A to 7C show characteristics of the emission intensity of the light beams after transmitting the optical shutter 13. FIG. 7A shows a characteristic when the light beams are transmitted with respect to the first shutter 30, similarly to FIG. 1. As shown in the figure, the light beam generated by the light source 1 becomes a light beam having an approximately single wavelength, which has a peak at a wavelength of λ1 only.

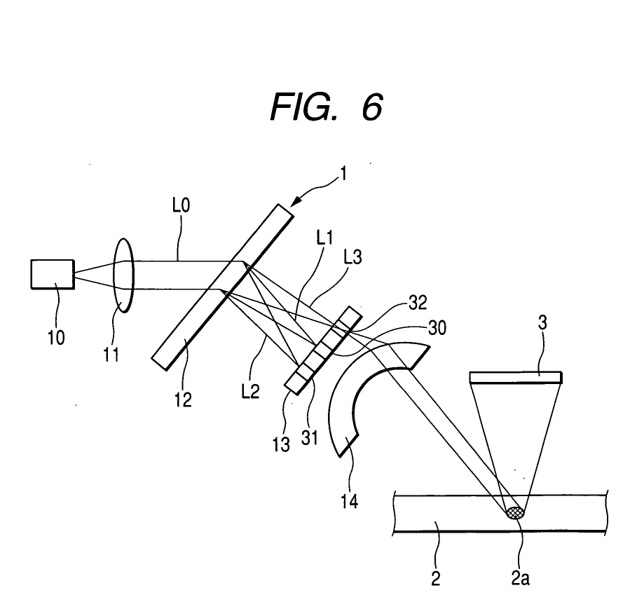

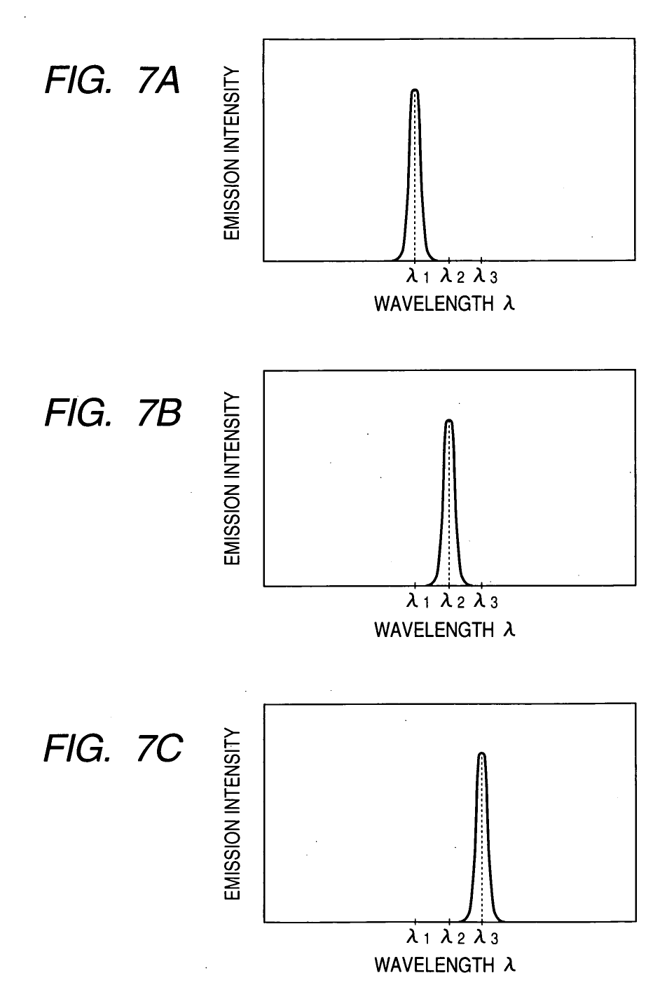

FIGS. 5 and 6 show that light beams, having different wavelengths from that of FIG. 1, are transmitted, respectively. In FIG. 5, the second shutter 31 of the optical shutter 13 is in a state in which the light beams are transmitted, and the first and third shutters 30 and 32 are in a state in which the light beams are non-transmitted. Thereby, the light beam L2 only, having a wavelength of λ2, passing through the second shutter 31 transmits the optical shutter 13. The light beam L2, which has passed through the optical shutter 13, is incident on the hologram 2a, which is formed in the recording medium 2, through a condensing means 14. As shown in FIG. 7B, the light beam is a light beam having an approximately single wavelength, which has a peak at a wavelength of λ2 only.

In FIG. 6, the third shutter 32 of the optical shutter 13 is in a state in which the light beams are transmitted, and the first and second shutters 30 and 31 are in a state in which the light beams are non-transmitted. Thereby, the light beam L3 only, having a wavelength of λ3, passing through the third shutter 32 transmits the optical shutter 13. The light beam L3, which has passed through the optical shutter 13, is incident on the hologram 2a, which is formed in the recording medium 2, through a condensing means 14. As shown in FIG. 7C, the light beam is a light beam having an approximately single wavelength, which has a peak at a wavelength of λ3 only.

As described above, when the incidence surface 20 and the emission surface 21 of the separation grating 12 are respectively formed with the diffraction grating, an emission angle difference in the light beams each having a different wavelength becomes small, but the emission angle difference is preferably enough such that each of the light beams can be independently transmitted or non-transmitted in the optical shutter 13. Meanwhile, when the separation grating 12 is formed with the hologram 24, it is possible to arbitrarily set the emission angle difference in the light beams each having a different wavelength, but even in this case, it is needed an angle difference by which multi-recorded holograms can be reproduced without being overlapped each other. Therefore, in the case in which the incidence surface 20 and the emission surface 21 of the separation grating 12 are respectively formed with the diffraction grating, much more light beams can be selected with a small angle difference, so that it is easy to increase the number of multi-recording.

Further, the condensing means 14 is composed of a lens which condenses each light beam, which has passed the optical shutter 13, onto approximately the same location of the recording medium 2. Since each light beam, separated for each wavelength by the separation grating 12, transmits a different location of the optical shutter 13, the incidence angles with respect to the hologram 2a become different by condensing each light beam at approximately the same location through the condensing means 14. By the difference in the incidence angles and the difference in the wavelengths, each information of the multi-recorded hologram 2a can be separately reproduced.

According to the hologram device of the invention, the light source includes a laser having plural peak wavelengths at the emission intensity of light beams to be generated, and a separation grating for emitting the light beams emitted from the laser at a plurality of different angles for each of the peak wavelengths, so that the light beams having a plurality of different wavelengths can be separated by the low-priced light source and the separation grating. Therefore, it is possible to reproduce holograms recorded by the multi-wavelength and the multi-angle with a simple and easy configuration.

Further, according to the hologram device of the invention, the light source further includes an optical shutter by which each of the light beams emitted from the separation grating is transmitted or non-transmitted, so that the multi-recorded holograms can be reproduced without being overlapped.

Furthermore, according to the hologram device of the invention, the incidence surface and the emission surface of the separation grating are respectively formed with a diffraction grating, so that the light beams each having a different wavelength can be separated by a minute angle difference. Therefore, it is possible to form a compact light source.

Moreover, according to the hologram device of the invention, the separation grating is formed with holograms, so that the angle difference in the light beams to be separated can be arbitrarily set. Accordingly, the device can be easily constructed.

In addition, according to the hologram device of the invention, a condensing means is provided between the light source, in which a wavelength can be tuned, and the recording medium, and that condenses each of the light beams passing through the optical shutter onto approximately the same location of the recording medium, so that it is possible to reproduce the multi-recorded holograms at approximately the same location of the recording medium.

Having described the embodiments of the present invention, it is to be understood that the present invention is not limited thereto, but various changes and modifications thereof can be made without departing from the spirit or scope of the invention.

1. A hologram device comprising a light source for generating light beams, in which the light beams emitted from the light source are incident on holograms formed on a recording medium and thus information recorded on the holograms is read,
wherein the light source includes:
a laser having plural peak wavelengths at the emission intensity of light beams to be generated; and
a separation grating for emitting the light beams emitted from the laser at a plurality of different angles for each of the peak wavelengths.

2. The hologram device according to claim 1,
wherein the light source further includes an optical shutter by which each of the light beams emitted from the separation grating is transmitted or non-transmitted.

3. The hologram device according to claim 1,
wherein an incidence surface and an emission surface of the separation grating are respectively formed with a diffraction grating.

4. The hologram device according to claim 2,
wherein an incidence surface and an emission surface of the separation grating are respectively formed with a diffraction grating.

5. The hologram device according to claim 1,
wherein the separation grating is formed with holograms.

6. The hologram device according to claim 2,
wherein the separation grating is formed with holograms.

7. The hologram device according to claim 1, further comprising:
a condensing means that is provided between the light source, in which a wavelength can be tuned, and the recording medium, and that condenses each of the light beams passing through the optical shutter onto approximately the same location of the recording medium.
